(19) United States
(12) Patent Application Publication
(10) Pub. No.: US 2003/0188061 A1
(43) Pub. Date: Oct. 2, 2003

(54) Device discovery and dynamic configuration of control application

(76) Inventors: Paul E. Luse, Chandler, AZ (US); Dieter E. Massa, Neckarsulm (DE)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/112,789

(22) Filed: Mar. 28, 2002

(51) Int. Cl. G06F 13/00

(52) U.S. Cl. 710/104; 710/8

(57) ABSTRACT

In one embodiment, a method is provided. The method of this embodiment may include the initiating of a scan of a bus, the determining, based at least in part upon the scan, of a location of a device, and, prior to the initiation of the scan, the controlling of coupling of the device to the bus. Of course, many modifications, variations, and alternatives are possible without departing from this embodiment.

### FIELD

This disclosure relates generally to the field of device discovery, and more specifically, to device discovery and configuration. It also relates to dynamic configuration of applications.

### BACKGROUND

In modular redundant array of independent or inexpensive disk (RAID) on motherboard (MROMB) techniques, MROMB circuitry residing on a circuit card, for example, may be used to configure and control, independently of a host processor residing on the motherboard, an input/output (I/O) controller that also may reside on the motherboard. MROMB hardware on the motherboard performs operations that enable the MROMB circuitry on the circuit card to configure and control the I/O controller independently of the host processor.

The I/O controller may be coupled to a bus comprised in the motherboard. Heretofore, the bus address of the I/O controller has been predetermined, and the circuit card has been preprogrammed with explicit knowledge of I/O controller's bus address.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is diagram that illustrates an embodiment of the claimed subject matter.

FIG. 2 is a diagram that illustrates MROMB motherboard hardware in greater detail.

FIG. 3 is a flowchart illustrating operations involved in practicing one embodiment of the claimed subject matter.

FIG. 4 is a flowchart illustrating operations that may be involved in configuring an I/O controller in accordance with one embodiment of the claimed subject matter.

FIG. 5 is a diagram that illustrates procedures that may be stored in memory in accordance with one embodiment of the claimed subject matter.

It should be understood that although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

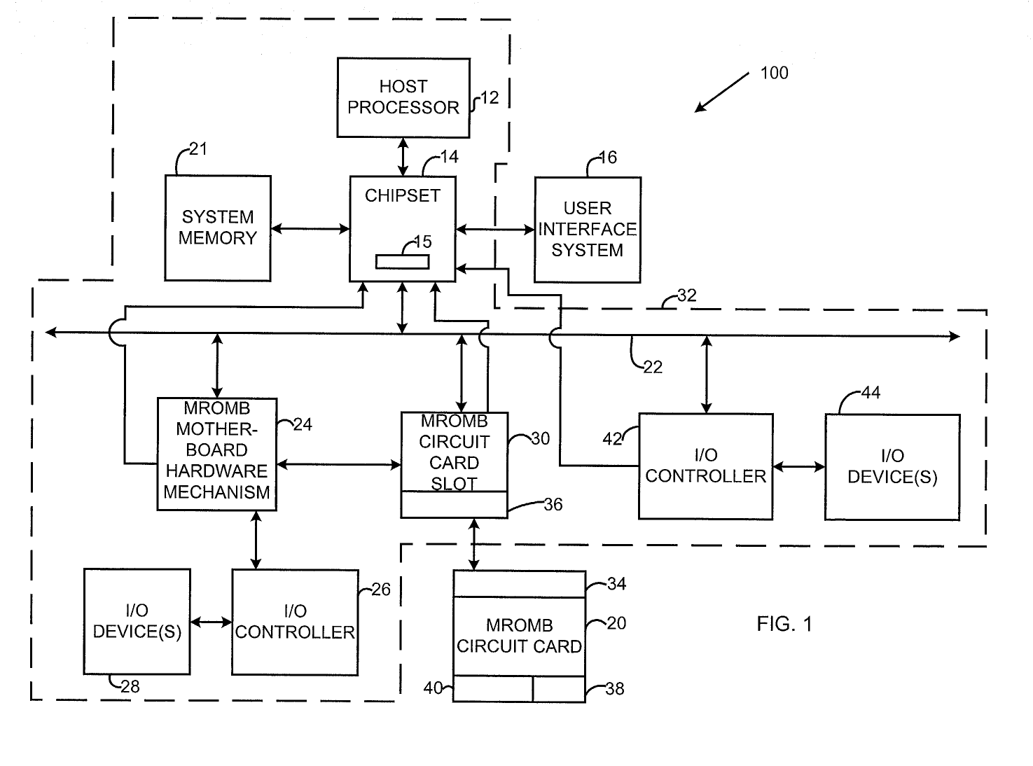

FIG. 1 illustrates a system embodiment 10 of the claimed subject matter. System 10 may include a host processor 12 coupled to a chipset 14. Host processor 12 may comprise, for example, an Intel® Pentium® III or IV microprocessor that is commercially available from the assignee of the subject application. Of course, host processor 12 instead may comprise another type of microprocessor without departing from this embodiment of the claimed subject matter. Chipset 14 may comprise a host bridge/hub system that may couple host processor 12, a system memory 21 and a user interface system 16 to each other and to a bus system 22. Chipset 14 may also include an I/O bridge/hub system (not shown) that may couple the host bridge/bus system to bus 22. Chipset 14 may comprise integrated circuit chips, such as those selected from integrated circuit chipsets commercially available from the assignee of the subject application (e.g., graphics memory and I/O controller hub chipsets), although other integrated circuit chips may also or alternatively be used without departing from this embodiment of the claimed subject matter. Additionally, chipset 14 may include an interrupt controller 15 that may process interrupts that it may receive from other components in system 100, such as, e.g., MROMB circuit card 20, when card 20 is properly inserted into circuit card bus extension slot 30, and I/O controller 26, and I/O controller 42. Of course, if system 100 is appropriately modified, card 20 need not comprise a circuit card, but if alternatively may comprise alternative structures, systems, and/or devices that may be coupled to bus 22, and exchange data and commands with other components in system 100 in accordance with embodiments of the claimed subject matter. User interface system 16 may comprise, e.g., a keyboard, pointing device, and display system that may permit a human user to input commands to, and monitor the operation of, system 100.

Bus 22 may comprise a bus that complies with the Peripheral Component Interconnect (PCI) Local Bus Specification, Revision 2.2, Jun. 8, 1998 available from the PCI Special Interest Group, Portland, Oreg., U.S.A. (hereinafter referred to as a “PCI bus”). Alternatively, if system 100 is appropriately modified, bus 22 instead may comprise a bus that complies with the PCI-X Specification Rev. 1.0a, published by and available from the aforesaid PCI Special Interest Group, Portland, Oreg., U.S.A. (hereinafter referred to as a “PCI-X bus”). It should be appreciated, however, that if system 100 is appropriately modified, bus 22 may comprise other types and configurations of bus systems, without departing from this embodiment of the claimed subject matter.

An I/O controller 26 may be coupled, via MROMB motherboard hardware mechanism 24, to chipset 14, PCI bus 22, and MROMB circuit card slot 30. I/O controller 26 may also be coupled to and control the operation of one or more I/O devices (hereinafter collectively or singly referred to as “I/O device 28”). I/O device 28 may comprise, for example, a set of one or more storage devices comprising, e.g., one or more magnetic disks, optical disks, or solid-state storage devices. The one or more storage devices may be configured as e.g., one or more arrays of mass storage devices.

Alternatively, I/O device 28, instead, may comprise one or more network adapter or interface devices that may be used to interface system 100 to one or more external computer networks. According to this alternative arrangement, I/O device 28 may exchange data and/or commands with external network devices (e.g., host or server computer nodes) via the one or more external computer networks.

System 100 also may include another I/O controller 42. I/O controller 42 may be coupled to bus 22. I/O controller 42 may also be coupled to and control the operation of one or more I/O devices (hereinafter collectively or singly referred to as “I/O device 44”). I/O device 44 may comprise, for example, a set of one or more storage devices comprising, e.g., one or more magnetic disks, optical disks, or solid-state storage devices. These one or more storage devices may be configured as e.g., one or more arrays of mass storage devices.

Alternatively, I/O device 44, instead, may comprise one or more network adapter or interface devices that may be used to interface system 100 to one or more external computer networks. According to this alternative arrangement, I/O device 44 may exchange data and/or commands with external network devices (e.g., host or server computer nodes) via the one or more external computer networks.

Processor 12, system memory 21, chipset 14, PCI bus 22, MROMB hardware mechanism 24, MROMB circuit card slot 30, I/O controller 26, and I/O controller 42 may be comprised in a single circuit board, e.g., a system motherboard 32. Although I/O device 28 and I/O device 44 are shown in FIG. 1 as being comprised in the motherboard 32, I/O device 28 and/or I/O device 44 need not be comprised in the motherboard 32. For example, I/O device 28 and I/O device 44 each may be comprised in one or more respective enclosures that are separate from the enclosure in which the motherboard 32 and the components comprised in the motherboard 32 are enclosed.

Depending upon the particular configuration and operational characteristics of I/O device 28, I/O controller 26 may exchange data and commands with I/O device 28 using any one of a variety of different communication protocols, e.g., a Small Computer Systems Interface (SCSI), Fibre Channel (FC), Ethernet, Serial Advanced Technology Attachment (S-ATA), or Transmission Control Protocol/Internet Protocol (TCP/IP) communication protocol. Of course, alternatively, I/O controller 26 may exchange data and/or commands with I/O device 28 using other communication protocols, without departing from this embodiment of the claimed subject matter.

In accordance with this embodiment, a SCSI protocol that may be used by controller 26 to exchange data and/or commands with I/O device 28 may comply or be compatible with the interface/protocol described in American National Standards Institute (ANSI) Small Computer Systems Interface-2 (SCSI-2) ANSI X3.131-1994 Specification. If a FC protocol is used by controller 26 to exchange data and/or commands with I/O device 28, it may comply or be compatible with the interface/protocol described in ANSI Standard Fibre Channel (FC) Physical and Signaling Interface-3 X3.303:1998 Specification. Alternatively, if an Ethernet protocol is used by controller 26 to exchange data and/or commands with I/O device 28, it may comply or be compatible with the protocol described in Institute of Electrical and Electronics Engineers, Inc. (IEEE) Std. 802.3, 2000 Edition, published on Oct. 20, 2000. Further, alternatively, if a S-ATA protocol is used by controller 26 to exchange data and/or commands with I/O device 28, it may comply or be compatible with the protocol described in “Serial ATA: High Speed Serialized AT Attachment,” Revision 1.0, published on Aug. 29, 2001 by the Serial ATA Working Group. Also, alternatively, if TCP/IP is used by controller 26 to exchange data and/or commands with I/O device 28, it may comply or be compatible with the protocols described in Internet Engineering Task Force (IETF) Request For Comments (RFC) 791 and 793, published September 1981. Also in accordance with this embodiment, if I/O device 28 is used to interface system 100 to one or more external computer networks, I/O device 28 may exchange data and/or commands with external host and/or server computer nodes via the one or more external computer networks using, e.g., the aforesaid TCP/IP and/or Ethernet protocols.

Similarly, depending upon the particular configuration and operational characteristics of I/O device 44, I/O controller 42 may exchange data/or and commands with I/O device 44 using one of the different types of communication protocols that may be used by I/O controller 26 (depending upon the particular configuration and operational characteristics of I/O device 28) to exchange data and/or commands with I/O device 28. Alternatively, I/O controller 42 may exchange data and commands with I/O device 44 using other communication protocols, without departing from this embodiment of the claimed subject matter.

Circuit card slot 30 may comprise a PCI expansion slot that comprises a PCI bus connector 36. The connector 36 may be electrically and mechanically mated with a PCI bus connector 34 that is comprised in MROMB circuit card 20. In addition to comprising the connector 34, circuit card 20 also may comprise an I/O processor 40 and computer-readable memory 38. Depending upon the particular embodiment, memory 38 may comprise one or more of the following types of computer-readable memories: semiconductor firmware memory, programmable memory, non-volatile memory, read only memory, electrically programmable memory, random access memory, cache memory, flash memory, magnetic disk memory, and/or optical disk memory. Additionally, it should be appreciated that, either additionally or alternatively, memory 38 may comprise other and/or later-developed types of computer-readable memory. Processor 40 may include integrated circuit chips (not shown) comprised in an integrated circuit chipset, such as those commercially available from the assignee of the subject application (e.g., the Intel® 80310 Chipset). Alternatively, processor 40 instead may comprise other integrated circuit chips (e.g., the Intel® 80960 RM/RN I/O processor, the Intel® 80321 processor, and/or other types of processors that are available from sources other than the assignee of the subject application), or other types of processors/integrated circuits without departing from this embodiment of the claimed subject matter.

Slot 30 and card 20 are constructed to permit card 20 to be inserted into slot 30. When card 20 is properly inserted into slot 30, connectors 34 and 36 become electrically and mechanically coupled to each other. When connectors 34 and 36 are so coupled to each other, card 20 becomes electrically coupled, via motherboard MROMB hardware mechanism 24, to controller 26 and to interrupt controller 15, and card 20 also becomes electrically coupled to bus 22.

In this embodiment of the claimed subject matter, MROMB hardware mechanism 24 in motherboard 32 permits a MROMB technique to be implemented in system 100. For example, hardware mechanism 24 may comprise MROMB circuitry of the type used in the Intel® SCB2 Server Board (commercially available from the Assignee of the subject application), which MROMB circuitry may permit a RAID input/output steering (RAIDIOS) technique to be implemented in system 100. Alternatively, hardware mechanism 24 may comprise embedded RAID logic (EMRL) MROMB circuitry of the type used in, e.g., the P3TDDR™ motherboard (commercially available from SUPERMICRO Computer Corporation of San Jose, Calif., United States of America), which MROMB circuitry may permit an EMRL technique to be implemented in system 100. Although hardware 24 will be described herein as implementing either a RAIDIOS or an EMRL technique, it should be understood that if system 100 is appropriately modified, hardware mechanism 24 instead may implement other types of MROMB techniques, without departing from this embodiment of the claimed subject matter.

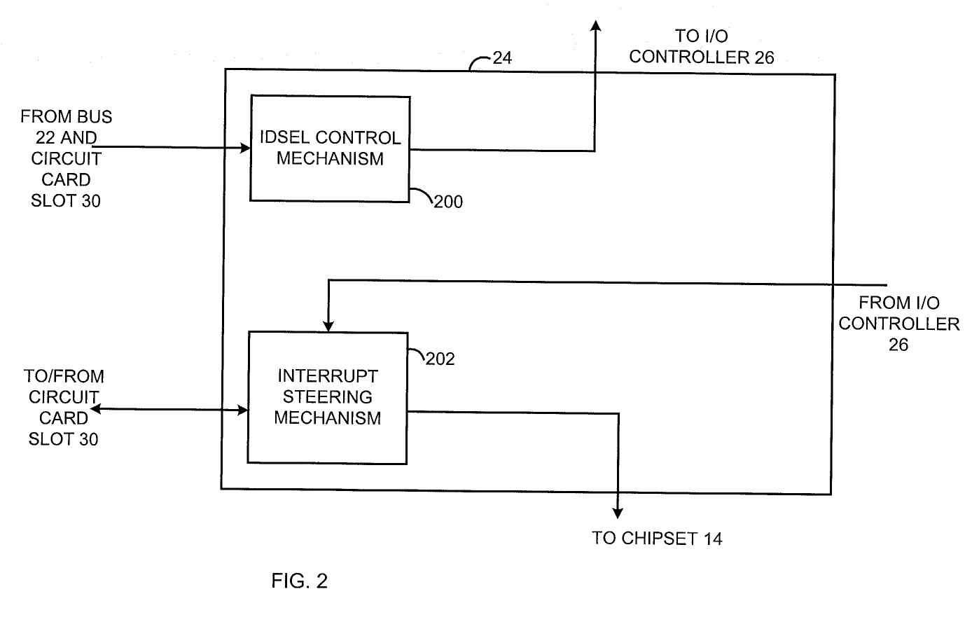

With particular reference now being made to FIG. 2, the particular configuration and operation of hardware mechanism 24 may vary depending upon whether hardware mechanism 24 implements a RAIDIOS or non-RAIDIOS type of MROMB technique (e.g., the EMRL MROMB technique). However, in either case, in this embodiment, the MROMB hardware 24 may comprise an Initialization Device Select (IDSEL) control mechanism 200 and an interrupt steering mechanism 202. IDSEL control mechanism 200 may be coupled to PCI bus 22, circuit card slot 30, and I/O controller 26. IDSEL control mechanism 200 may include circuitry that may controllably couple an IDSEL signal line of I/O controller 26 to, or de-couple that line from PCI bus 22, based at least in part upon a control signal provided from slot 30 to mechanism 200.

As is well known to those skilled in the art, an IDSEL signal line of I/O controller 26 may be coupled to a predetermined one of the address lines of bus 22, and the IDSEL signal that may be supplied to controller 26 via that line may be used during configuration cycles (such as, for example, following a reset of system 100) as a select or enable signal to enable configuration and/or control of the I/O controller during such configuration cycles. In accordance with this embodiment, when card 20 is absent from slot 30, a control signal is supplied to mechanism 200 from slot 30 that results in mechanism 200 coupling this IDSEL signal line to bus 22 in order to allow host processor 12 to drive that line during host processor-initiated configuration cycles. However, when card 20 is properly inserted into slot 30, slot 30 supplies a control signal to mechanism 200 that results in mechanism 200 de-coupling the IDSEL line of controller 26 from bus 22 to “hide” controller 26 from host processor 12 during such cycles. Thereafter, by appropriately controlling this control signal, card 20 may control coupling of I/O controller 26 to, and de-coupling of I/O controller 26 from bus 22, via the IDSEL line of controller 26, by control mechanism 200, during multiple scans of bus 22 initiated by I/O processor 40, in order to permit controller 26 to be discovered, configured and/or controlled by card 20, instead of by host processor 12. As used herein, “controlling coupling” of a device (such as, for example, I/O controller 26), to a bus (such as, for example, bus 22) means controlling provision of one or more signal paths (such as, for example, the IDSEL line of controller 26) that may permit one or more signals (such as, for example, the IDSEL signal of controller 26) to propagate to controller 26 from the bus, and/or from controller 26 to the bus. Although not shown in the Figures, with the exception of the one predetermined address line of bus 22 that is used to propagate the IDSEL signal to the I/O controller 26, in this embodiment, the signal lines of PCI bus 22 may be directly coupled to the I/O controller 26 in such a way as to permit I/O controller 26 to exchange data and/or commands, via bus 22, with other devices in system 100 that may also be coupled to bus 22.

Interrupt steering mechanism 202 may be coupled to circuit card slot 30, I/O controller 26, and interrupt controller 15 in chipset 14. Mechanism 202 may selectively couple one or more interrupt signal lines from I/O controller 26 to card slot 30. Mechanism 202 also may selectively couple these one or more interrupt signal lines to interrupt controller 15 in chipset 14 based upon a control signal supplied to mechanism from slot 30. This control signal may result in these one or more interrupt signal lines of I/O controller 26 being coupled to interrupt controller 15 when card 20 is absent from slot 30, and may result in these one or more interrupt signal lines being de-coupled from interrupt controller 15 when card 20 is properly inserted in slot 30. Thus, when card 20 is absent from slot 30, interrupt signals generated by I/O controller 26 may be routed or steered by mechanism 202 to interrupt controller 15 for processing by interrupt controller 15. However, when card 20 is present in slot 30, interrupt signals generated by I/O controller 26 may be routed by mechanism 202 to card 20 for processing by processor 40 in card 20. Slot 30 may transmit interrupt signals generated by card 20, when card 20 is properly inserted into slot 30, to interrupt controller 15 to permit these interrupts to be handled by interrupt controller 15.

If hardware mechanism 24 implements RAIDIOS, IDSEL control mechanism 200 may include a transistor-based switching mechanism (not shown) that may be either in a first state, in which the IDSEL signal line of I/O controller 26 may be coupled to PCI bus 22, or in a second state, in which that signal line may be de-coupled from PCI bus 22. In one embodiment, the control signal that controls the state of this switching mechanism may be the Joint Test Action Group (JTAG) IEEE Standard Test Access Port and Boundary-Scan Architecture Test Mode Select (TMS) signal from PCI bus slot 30. This TMS signal may be compliant with IEEE Standard 1149.1-1990. That is, the TMS signal pin in PCI slot 30 may be coupled to control mechanism 200, and the state of the signal (hereinafter termed the “TMS signal” of slot 30) propagating to control mechanism 200 through this TMS signal pin of slot 30 may control the state of the switching mechanism in control mechanism 200. Slot 30 may be constructed such that, when card 20 is absent from slot 30, the state of this TMS signal may be driven to a logic state (e.g., a high logic state) that may result in the switching mechanism in control mechanism 200 connecting to bus 22 the IDSEL signal line of controller 26. However, when card 20 is properly inserted into slot 30, processor 40 of card 20 may control the logic state of this TMS signal. Thereafter, processor 40 may control the logic state of this TMS signal in the manner that will be described below.

Additionally, if hardware 24 implements RAIDIOS, interrupt steering mechanism 202 may include a plurality of tri-state buffers (not shown) controlled by the logic state of the signal (hereinafter termed the “TDI signal” from slot 30) propagating through the JTAG Test Data Input (TDI) pin of slot 30. These tri-state buffers may permit predetermined interrupt signals from controller 26 to be received by interrupt controller 15 when the signal propagating through the TDI pin of slot 30 is of a predetermined logic level (e.g., a high logic state). Slot 30 may be constructed such that, when card 20 is absent from slot 30, the signal propagating through the TDI pin of slot 30 may be driven to a high logic state, and conversely, when card 20 is properly inserted in slot 30, this signal may be driven to a low logic state and the interrupt signals from I/O controller 26 may be routed to predetermined interrupt signal pins of slot 30. An interrupt signal pin of slot 30 may be coupled to interrupt controller 15.

As stated previously, the construction of hardware mechanism 24 may vary depending upon the particular MROMB technique that may be implemented. Thus, if hardware mechanism 24 implements a non-RAIDIOS MROMB technique, the construction and operation of IDSEL control mechanism 200, interrupt steering mechanism 202, and the control signals provided to hardware mechanism 24 from slot 30 may differ from those described for the RAIDIOS technique. Processor 40 may issue control signals that may result in card 20 providing appropriate control signals to hardware mechanism 24 to control hardware mechanism 24 so as to implement such a MROMB technique. In this embodiment, card 20 may issue appropriate control signals to hardware mechanism 24. More specifically, card 20 may include firmware program instructions stored in memory 38 that, when executed by processor 40, may result in card 20 issuing appropriate control signals to hardware 24 to control and/or configure I/O controller 26.

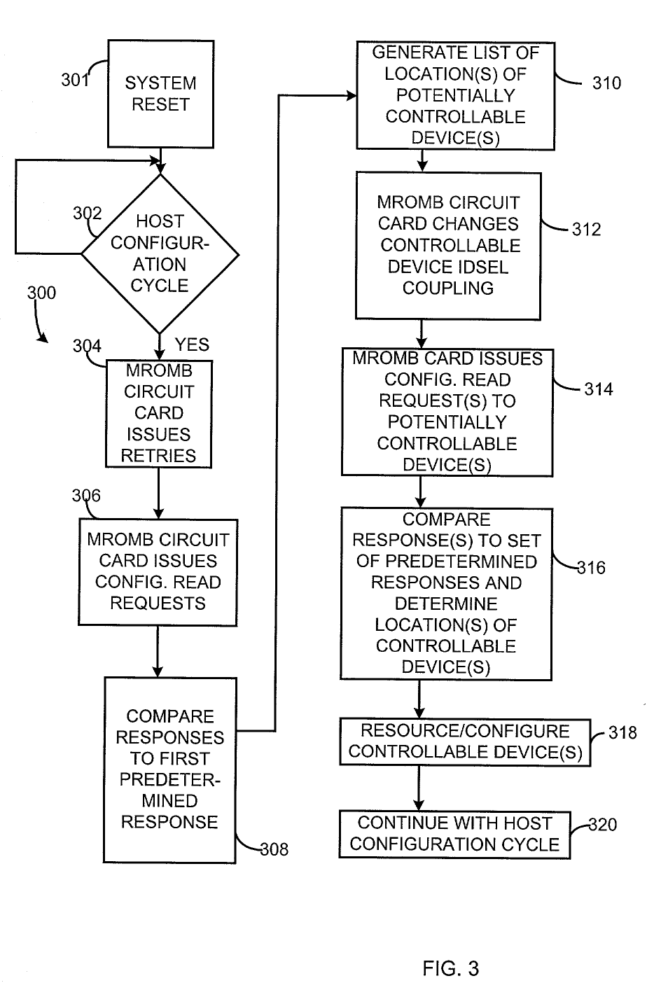

FIG. 3 is a flowchart that illustrates these and other operations 301 that may be carried out in system 100, in accordance with one embodiment. After a reset of system 100, such as operation 301 in FIG. 3, I/O processor 40 in card 20 may execute one or more subroutines or procedures comprised in the firmware program instructions stored in memory 38. This may result in I/O processor 40 determining, based upon signals propagating through bus 22, whether host processor 12 has initiated configuration cycles for devices (hereinafter termed “bus addressable devices,” e.g., I/O controller 26, I/O controller 42, and card 20) that are coupled to, and are addressable and/or configurable via bus 22 in such configuration cycles, such as operation 302 in FIG. 3. As will be appreciated by those skilled in the art, MROMB motherboard hardware 24 comprises a controllable interface through which interrupt and IDSEL signals of I/O controller 26 may propagate.

After I/O processor 40 has determined that host processor 12 has initiated such configuration cycles, I/O processor 40 may signal card 20. This may result in card 20 issuing retries to host processor 12 to hold-off these configuration cycles initiated by the host processor 12, such as in operation 304. Thereafter, while host processor-initiated configuration cycles initiated are being held-off, I/O processor 40 may signal card 20 to initiate and/or execute a first bus scan. As used herein, a “bus scan” is the issuance of one or more requests (such as, for example, configuration read requests) to one or more addresses of the bus to obtain one or more responses (such as, for example, configuration read responses). This first bus scan may permit card 20 to determine any bus addressable devices in system 100 that potentially may be controllable and/or configurable by card 20 using hardware 24, and/or the bus addresses at which same may be located. As used herein, a first device is considered to be “configurable” by a second device, if the second device is capable, at least in part, of controlling and/or selecting at least one feature, mode, and/or characteristic of operation of the first device. In order to determine which, if any, of the bus addressable devices in system 100 potentially may be controllable and/or configurable by card 20, card 20 may issue, via bus 22, a first set of configuration read requests to some or all of the bus addressable devices. Thus, in this embodiment, the first set of configuration read requests may comprise configuration read requests issued to all of the bus addressable devices, including I/O controller 26 and I/O controller 42. While card 20 issues the first set of configuration read requests, card 20 controls hardware 24 in such a way as to ensure that the IDSEL line of controller 26 is de-coupled from bus 22.

After issuing the first set of configuration read requests, processor 40 may receive via bus 22 the responses to the first set of configuration read requests. Processor 40 may compare each of these responses to a first predetermined response, such as operation 308 in FIG. 3. In this embodiment, the first predetermined response may comprise a data word FFFFFFFF hexadecimal, and result in a master abort condition (such as, for example, a termination by card 20 of the configuration read bus transaction that resulted in the first predetermined response following a failure by card 20 to receive an assertion of a device select signal during that transaction). If a given one of these responses matches the first predetermined response and results in a master abort condition, this may constitute an error message that may have been generated in system 100 for one of two possible reasons. One possible reason for such an error message may be that no bus addressable device is present in system 100 at the bus address to which the configuration read request (hereinafter termed “the configuration read address”) that generated the given response was sent. Another possible reason for the generation of the error message may be that a bus addressable device is located in system 100 at the configuration read address, but the device's IDSEL signal was not asserted when the device received the configuration read request and, therefore, the device was not enabled to respond to the configuration read request. If so, the bus addressable device present at that address may be controllable and/or configurable by card 20 using hardware 24. During the issuance of the first set of configuration read requests, that device's IDSEL line was de-coupled from bus 22. However, if a given one of the responses does not match the first predetermined response, the bus addressable device located at the address to which the configuration read request was sent that resulted in the given response is not controllable by card 20, using hardware 24.

For example, in system 100, controller 26 may be controllable and/or configurable by card 20 using hardware 24. Therefore, the response received by card 20 to a configuration read request issued by card 20 to the bus address of controller 26 would match the first predetermined response and result in a master abort condition. However, in system 100, controller 42 may not be controllable and/or configurable by card 20 using hardware 24. Accordingly, the response received by card 20 to a configuration read request issued by card 20 to the bus address of controller 42 would not match the first predetermined response.

As used herein, a “location of a device” may be, comprise, or be specified by an identifier, such as, an address, of the device (e.g., a bus address if the device is coupled to a bus), that may be used to identify the device for the purpose of enabling a data and/or command exchange to occur that involves the device (e.g., a data and/or command exchange via the bus). In this embodiment, after processor 40 has performed a comparison, such as operation 308 in FIG. 3, processor 40 may generate a list of locations, such as, for example, bus addresses (e.g., such as, addresses in bus 22), at which bus addressable devices that may be controllable and/or configurable by card 20, using hardware 24 might exist, as illustrated by operation 310 in FIG. 3. After completing the list, processor 40 may signal card 20 to issue an appropriate control signal to hardware 24 to “unhide” all of the bus addressable devices in system 100 that may be controlled and/or configured by card 20, using hardware 24, as illustrated by operation 312 in FIG. 3. For example, in system 100, a bus addressable device that may be controlled and/or configured by card 20, using hardware 24, is I/O controller 26. Therefore, in system 100, processor 40 accomplishes operation 312 by signaling circuit card 20 to issue an appropriate control signal to hardware 24. This may result in hardware 24 coupling the IDSEL line of I/O controller 26 to bus 22.

After operation 312 is complete, processor 40 may initiate a second bus scan by signaling card 20 to issue, via bus 22, respective configuration read requests to bus addresses, such as those listed in the list generated in operation 310. This is illustrated by operation 314 in FIG. 3. After these configuration read requests have been issued, processor 40 may receive, via bus 22, the responses to these configuration read requests. Processor 40 first may compare each of these responses to the first predetermined response. If a given one of these responses matches the first predetermined response, processor 40 may determine that no bus addressable device is present in system 100 at the bus address to which the configuration read request that generated the given response was sent.

Conversely, if a given one of these responses does not match the first predetermined response, processor 40 then may determine, based upon the given response, respective vendor and device identification information associated with the respective bus addressable device that generated by the given response. That is, each respective bus address device in system 100 may transmit via bus 22, when the device receives a configuration read request addressed to the device and the device's respective IDSEL line is asserted, a respective response that may include (for example, in a portion of the respective response, such as the first data word) respective vendor and device identification information (e.g., vendor and device identification numbers) that may identify the device's respective vendor and device type.

If a respective one of these responses does match the first predetermined response, processor 40 may compare the respective vendor and device identification information contained in the respective response to respective vendor and device identification information of predetermined bus addressable devices that are known to be controllable and/or configurable by card 20. If processor 40 determines that respective vendor and device identification information in such a respective response matches the vendor and device identification information of one of these predetermined bus addressable devices, processor 40 may determine that the respective bus addressable device that generated the respective response is controllable and/or configurable by processor 40 using hardware 24, and processor 40 may resource and configure that respective bus addressable device using hardware 24, as illustrated by operation 318 in FIG. 3. Conversely, if processor 40 determines that the respective vendor and device identification information in such a respective response does not match the vendor and device identification information of any of these predetermined bus addressable devices, processor 40 may determine that the respective bus addressable device that generated the respective response is not controllable and/or configurable by processor 40 using hardware 24, and accordingly, processor 40 may not attempt to configure or resource processor 40 using hardware 24. After processor 40 has configured and resourced all of the bus addressable devices that are controllable and configurable by processor 40 using hardware 24, processor 40 may stop generating retries to hold-up the host processor's configuration cycles, and may permit the host processor's normal boot process to continue unhindered, as illustrated by operation 320 in FIG. 3.

For purposes of illustrating this, in system 100, I/O controller 26 may be a bus addressable device that is controllable and/or configurable by processor 40, using hardware 24. Accordingly, in system 100, the bus address of controller 26 may be comprised in the list generated in operation 310. Additionally, a configuration read request may be issued to controller 26 in operation 314, and a response to this request may be generated by controller 26. When processor 40 receives this response from controller 26, processor 40 may compare that response to the first predetermined response, and may determine that this response from controller 26 does not match the first predetermined response. Processor 40 next may compare the vendor and device identification in this response to the vendor and device information of the predetermined bus addressable devices, and may determine based at least in part on this comparison that controller 26 is controllable and/or configurable by processor 40, using hardware 24. Accordingly, processor 40 then may configure and resource controller 26, using hardware 24. Thereafter, processor 40 may stop generating retries to hold-up the host processor's configuration cycles and may permit the host processor's normal boot process to continue unhindered.

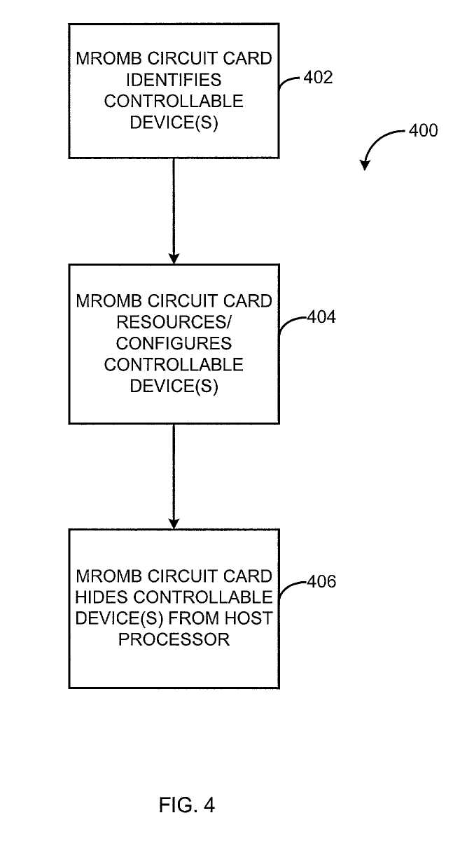

As stated previously, depending upon whether hardware 24 implements a non-RAIDIOS MROMB technique or a RAIDIOS MROMB technique, for example, the configuration and/or operation of IDSEL control mechanism 200, interrupt steering mechanism 202, and the control signals provided to hardware 24 from slot 30 may differ. Thus, depending upon which of these two (or any other) MROMB techniques hardware 24 carries out, the particular operations carried out, and control signals utilized by processor 40 may vary. For purposes of illustration, with particular reference being made to FIG. 4, operations 400 that may be carried out by processor 40 in system 100 to configure and resource controller 26 when hardware 24 implements the RAIDIOS technique are described below.

Operations 400 may begin with operation 402, in which processor 40 may obtain configuration information from I/O controller 26 that may identify the particular device type and characteristics of I/O controller 26. Based upon this information, processor 40 then may signal card 20 to supply and store in controller 26 and memory 21 appropriate control and/or configuration-related information to properly resource controller 26 and/or to permit controller 26 to operate in accordance with enhanced I/O procedures, as illustrated by operation 404 in FIG. 4. As a result of the signaling of card 20 by processor 40, card 20 may apply, via bus 22, signals to memory 21 and/or controller 26. The application of such signals may result in the storing of such control and/or configuration-related information in locations in memory 21 that may be pre-selected so as not to conflict with locations in memory 21 that might be selected by host processor 12, such as, during cycles initiated and/or carried out by the host processor 12, for storage of control and configuration-related information for devices configured by host processor 12. If I/O device 28 comprises an array of disk mass storage devices, these I/O procedures may permit I/O controller 26 and the array to be used as a RAID storage controller and/or RAID array, respectively. Alternatively, these I/O procedures may permit such a RAID array to operate in accordance with RAID procedures or levels. Further alternatively, if I/O device 28 is used to interface system 100 to an external computer network, the I/O procedures may permit I/O controller 26 to be used as a server management controller, and/or may permit controller 26 and device 28 to utilize additional communication protocols.

Thereafter, processor 40 may cause card 20 to toggle the TMS signal to a low logic state. This may hide I/O device 26 from host processor 12. This may conclude operations 400.

After host processor 12 has completed its configuration cycles in system 100, I/O processor 40 may receive and process interrupts received from I/O controller. I/O processor 40 may generate and supply to I/O controller 26 commands and/or data, in response to these interrupts.

Although not shown in the Figures, card 20 may include additional circuitry that may facilitate or permit card 20 to carry out the operations described herein and/or additional operations. For example, such additional circuitry in card 20 may include logic that prevents assertion of the TMS signal by card 20 unless the PCI GNT signal (not shown) of bus 22 is also asserted for card 20. This may permit card 20 to undertake and/or continue operations directed to discovery and/or configuration of bus addressable devices, such as, for example, controller 26, that may be controllable and/or configurable by processor 40 using hardware 24, after card 20 has ceased issuing retries to processor 12 and/or prior to card 20 issuing such retries to processor 12.

System 100 has been described as comprising a single bus addressable device, such as, controller 26, that may be controlled and/or configured by card 20 using hardware 24. However, system 100 may include a plurality of bus addressable devices that may be controllable and/or configurable by card 20 using hardware 24. In such a modified system 100, hardware 24 may include a plurality of IDSEL control mechanisms and interrupt steering mechanisms. Respective IDSEL control mechanisms may control whether bus 22 is coupled to respective IDSEL lines of respective bus addressable devices that may be controllable and/or configurable by card 20 using hardware 24. Additionally, respective interrupt steering mechanisms may permit respective sets of interrupts generated by respective bus addressable devices to be routed either to card 20 or to system interrupt controller 15. The IDSEL control mechanisms may be controlled by the TMS signal. The interrupt steering mechanisms may be controlled by the TDI signal.

In operations 300 shown in FIG. 3, configuration read requests may be issued to some or all of the bus addresses while the IDSEL line of controller 26 is de-coupled from bus 22. Thereafter, configuration read requests may be issued, while that IDSEL line is coupled to bus 22, to a subset of these address at which processor 40 determines bus addressable devices might be located that might be controllable and/or configurable by processor 40 using hardware 24.

However, alternatively, configuration read requests may be issued to some or all of the bus addresses while the IDSEL line of controller 26 is coupled to bus 22. In this alternative arrangement, the responses received by processor 40 to the configuration read requests may be compared to the first predetermined response, and the configuration read addresses from which responses are received that do not match the first predetermined response may be recorded in the list. Thereafter, the IDSEL line of controller 26 may be de-coupled from bus 22, and configuration read requests may be issued to the bus addresses in the list. Processor 40 may compare the responses to this last set of configuration read requests to the first predetermined response, and a configuration read address from which a responses is received that matches the first predetermined response may be designated by processor 40 as a location at which a bus addressable device may exist that might be controllable and/or configurable by processor 40 using hardware 24. Processor 40 may obtain vendor and device identification information for I/O controller 26 from the response issued from controller 26 to the configuration read request issued to controller 26 when the IDSEL line of controller 26 was coupled to bus 22.

Thus, in summary, in one embodiment of the claimed subject matter, a circuit card is provided that includes a connector that may be used to couple the card to a bus in a motherboard. The motherboard also may include a host processor, MROMB motherboard hardware, and one or more bus addressable devices coupled to the bus. When the card is coupled to the bus, circuitry in the card may also be coupled to the bus. The circuitry may include an I/O processor and associated firmware memory. When the circuitry in the card is coupled to the bus, the I/O processor in the circuitry may be capable of initiating a scan of the bus, determining, based at least in part upon the scan, one or more respective locations of the one or more devices, and, prior to the initiating of the scan, controlling coupling of the one or more devices to the bus.

In accordance with one embodiment, an I/O processor in an MROMB card may discover, configure, and/or control one or more bus addressable devices in a motherboard, using MROMB hardware in the motherboard, regardless of the specific bus addresses at which such devices may be located. Advantageously, this makes it unnecessary to locate such devices at predetermined bus addresses and/or to program the I/O processor with explicit knowledge of such predetermined bus addresses. Advantageously, this enhances the ability of the MROMB card to interoperate with different configurations of motherboards and bus addressable devices.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims.

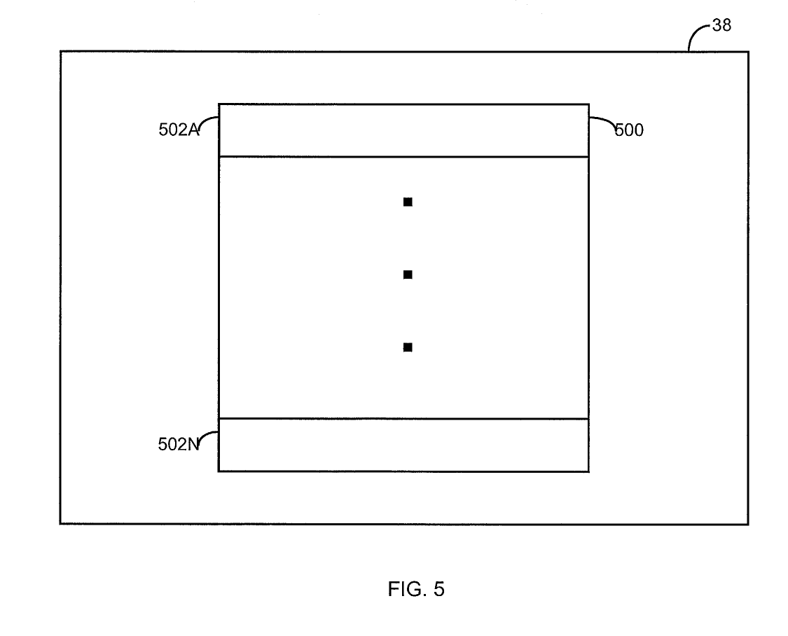

For example, as illustrated in FIG. 5, memory 38 may store a plurality of different control and/or communication code modules 500. Among modules 500 may be a plurality of different groups 502A . . . 502N of one or more control and/or communication program code modules each, from which processor 40 may build and/or generate one or more respective groups of program procedures that, when executed by processor 40, may result in processor 40 being able to control and/or communicate with different respective types and/or configurations of I/O controllers. Processor 40 may compare configuration information of the devices in system 100 that processor 40 determines to be controllable and/or configurable by processor 40 using hardware 24 (for example, configuration information obtained from I/O controller 26 in operation 402 illustrated in FIG. 4) to predetermined configuration information of different types and/or configurations of I/O controllers that processor 40 may be enabled to control and/or communicate as a result of execution of procedures built and/or generated from respective code module groups 502A . . . 502N. More specifically, processor 40 may associate respective predetermined configuration information of these different types and/or configurations of I/O controllers with respective groups 502A . . . 502N of code modules from which processor 40 may build and/or generate respective sets of one or more procedures each, that when executed by processor 40, may result in processor 40 being able to control and/or communicate with these different types and/or configurations of I/O controllers. Processor 40 may select from modules 500, based at least in part upon configuration information obtained in operation 402 in FIG. 4 from the devices that processor 40 determines to be controllable and/or configurable by processor 40 using hardware 24, one or more respective groups 502A . . . 502N of code modules 500 from which may be built and/or generated one or more respective sets of one or more program procedures each, that when executed by processor 40, may result in processor 40 being able to control and/or communicate with such devices.

For example, in this embodiment, group 502A may comprise one or more code modules from which may be built and/or generated physical and/or logical RAID stack procedures, cache and/or I/O management procedures, etc. that when executed by processor 40 may permit processor 40 to control and/or communicate with a first type of I/O controller that may exchange data and/or commands with a set of storage devices using a SCSI protocol. Conversely, in this embodiment, group 502N may comprise one or more code modules from which may be built and/or generated physical and/or logical RAID stack procedures, cache and/or I/O management procedures, etc. that when executed by processor 40 may permit processor 40 to control and/or communicate with a second type of I/O controller that may exchange data and/or commands with a set of storage devices using a FC protocol. If the configuration information obtained in operations 402 in FIG. 4 from I/O controller 26 indicates that I/O controller 26 is the first type of I/O controller, processor 40 may select one or more code modules comprised in group 502A, and may build and/or generate from these one or more code modules from group 502A one or more program procedures that may be executed by processor 40. Conversely, if the configuration information obtained in operations 402 in FIG. 4 from I/O controller 26 indicates that I/O controller 26 is the second type of I/O controller, processor 40 may select one or more code modules comprised in group 502N, and may build and/or generate from these one or more code modules from group 502N one or more program procedures that may be executed by processor 40.

Additional modifications are also possible within the scope of the claims. Accordingly, the claims are intended to cover all such equivalents.

What is claimed is:

1. A method comprising:
initiating a scan of a bus;
determining, based at least in part upon the scan, a location of a device; and
prior to initiation of the scan, controlling coupling of the device to the bus.

2. The method of claim 1, wherein:
the scan is initiated by a first processor; and
the method also comprises holding off of a configuration cycle initiated by a second processor.

3. The method of claim 1, wherein:
the controlling of the coupling of the device to the bus comprises controlling application of an enable signal to the device.

4. The method of claim 1, wherein:
the determining of the location of the device is also based at least in part upon another scan of the bus.

5. The method of claim 1, wherein:
the scan comprises issuance of one or more requests to one or more addresses of the bus.

6. The method of claim 5, further comprising:
comparing, with one or more predetermined responses, one or more responses to the one or more requests.

7. Circuitry comprising:
a first processor to initiate a scan of a bus, to determine, based at least in part upon the scan, a location of a device, and, prior to initiating the scan, to control coupling of the device to the bus.

8. The circuitry of claim 7, wherein:
the first processor is also to hold off a configuration cycle initiated by a second processor.

9. The circuitry of claim 7, wherein:
control by the first processor of coupling of the device to the bus comprises controlling coupling of an input of the device to the bus.

10. The circuitry of claim 7, wherein:
determining by the first processor of the location of the device is also based at least in part upon another scan of the bus.

11. The circuitry of claim 7, wherein:
the scan comprises issuance of one or more requests to one or more addresses of the bus.

12. The circuitry of claim 11, wherein:
the first processor is also to compare, with one or more predetermined responses, one or more responses to the one or more requests.

13. An article comprising:
a storage medium having stored thereon instructions that when executed by a machine result in the following:
initiating of a scan of a bus;
determining, based at least in part upon the scan, of a location of a device; and
prior to the initiating of the scan, controlling of coupling of the device to the bus.

14. The article of claim 13, wherein:
when executed by the machine, the instructions also result in holding off of a configuration cycle initiated by a second processor.

15. The article of claim 13, wherein:
the controlling of the coupling of the device to the bus comprises controlling application of an enable signal to the device.

16. The article of claim 13, wherein:
the determining of the location of the device is also based at least in part upon another scan of the bus

17. The article of claim 13, wherein:
the scan comprises issuance of one or more requests to one or more addresses of the bus.

18. The article of claim 17, further comprising:
comparing, with one or more predetermined responses, one or more responses to the one or more requests.

19. A system comprising:
a circuit board including a processor, a bus, and one or more devices;
circuitry capable of being coupled to the bus, and when the circuitry is coupled to the bus, the circuitry is also capable of initiating a scan of the bus, determining, based at least in part upon the scan, one or more respective locations of the one or more devices, and, prior to the initiating of the scan, controlling coupling of the one or more devices to the bus.

20. The system of claim 19, wherein:
the processor comprises a host processor;
the one or more devices comprise at least one of a data storage controller, a network data communication controller, and a server management controller; and
the circuitry comprises an input/output (I/O) processor.

21. The system of claim 19, wherein:
the one or more devices comprise a plurality of devices.

22. The system of claim 19, wherein:
the circuitry is also capable of determining one or more types of the one or more devices.

23. The system of claim 19, wherein:
the circuit board also includes a modular redundant array of inexpensive disks (RAID) on motherboard (MROMB) mechanism; and
the circuitry is also capable of applying to the mechanism a control signal to control, at least in part, the mechanism.

24. The system of claim 19, further comprising:
a circuit card that comprises the circuitry, the circuit card being capable of being coupled to the bus.

25. The system of claim 19, wherein:
the circuit board also includes an interrupt controller and a mechanism to control application of one or more interrupt signals from the one or more devices to the interrupt controller.

26. The system of claim 19, wherein:
the circuit board also includes a mechanism to control whether the one or more devices may receive one or more enable signals from the bus.

27. The system of claim 19, wherein:
the scan comprises issuance of one or more requests to the one or more devices; and
the circuitry is also capable of comparing one or more responses to the one or more requests to predetermined responses.

28. The system of claim 19, wherein:
the circuitry is also capable of initiating another scan of the bus; and
each of the scans comprises issuance of one or more requests to the one or more devices.

29. The system of claim 28, wherein:
at least one of the one or more devices is capable of receiving an Initialization Device Select (IDSEL) signal;
during one of the scans, the at least one of the one or more devices receives the IDSEL signal; and
during the other of the scans, the at least one of the one or more devices does not receive the IDSEL signal.

30. The system of claim 29, wherein:
the circuitry is capable of controlling whether the at least one of the one or more devices receives the IDSEL signal.

31. A method comprising:
initiating a scan of a bus;
prior to initiation of the scan, controlling coupling of a device to the bus;
obtaining information from the device; and
selecting, based at least in part upon the information, one or more code modules from which to build one or more procedures to permit at least one of control of and communication with the device.

32. The method of claim 31, wherein:
the one or more procedures, when executed, permit the at least one of control of and communication with a plurality of different types of devices.

33. Circuitry comprising:
a first processor to initiate a scan of a bus, to control coupling of a device to the bus prior to initiation of the scan, to obtain information from the device, and to select, based at least in part upon the information, one or more code modules from which to build one or more procedures that when executed by first processor permit at least one of control of and communication with the device by the first processor.

34. The circuitry of claim 33, wherein:
the first processor is to select the one or more code modules from a plurality of groups of code modules.

35. An article comprising:
a storage medium having stored thereon instructions that when executed by a machine result in the following:
initiating a scan of a bus;
prior to initiation of the scan, controlling coupling of a device to the bus;
obtaining information from the device; and
selecting, based at least in part upon the information, one or more code modules to be built into one or more procedures to permit at least one of control of and communication with the device.

36. The article of claim 35, wherein:
the one or more procedures, when executed, permit the at least one of control of and communication with a plurality of different types of devices.

37. A system comprising:
a circuit board including a processor, a bus, and a device;
circuitry capable of being coupled to the bus, and when the circuitry is coupled to the bus, the circuitry is also capable of initiating a scan of a bus, prior to initiation of the scan, controlling coupling of a device to the bus, obtaining information from the device, and selecting, based at least in part upon the information, one or more code modules to be built into one or more procedures to permit at least one of control of and communication with the device.

38. The system of claim 37, wherein:
the processor comprises a host processor; and
the circuitry comprises an I/O processor.
